(19) United States
(12) Patent Application Publication
(10) Pub. No.: US 2007/0273111 A1
(43) Pub. Date: Nov. 29, 2007

(54) Hand Carrier

(76) Inventor: Tae Wook Kim, Gyunggi-do (KR)

Correspondence Address: KNOBBE MARTENS OLSON & BEAR LLP, 2040 MAIN STREET, FOURTEENTH FLOOR, IRVINE, CA, 92614, US

(21) Appl. No.: 10/578,945

(22) PCT Filed: Jan. 10, 2004
(86) PCT No.: PCT/KR04/00029

§ 371 Date: May 17, 2007

(30) Foreign Application Priority Data
Nov. 7, 2003 (KR) 20-2003-0034886

(51) Int. Cl. B62B 1/04

(52) U.S. Cl. 280/30

(57) ABSTRACT

The present invention relates to a hand carrier that can be loaded with a bag or all other varying articles, which can be carried in convenience. The hand carrier (10) according to the present invention is characterized by comprising

a lower part-supporting member (20);

at least one support (30) perpendicularly connected to the lower part-supporting member (20) and equipped with a grip (80) at the end of its upper part;

at least one support-connecting member (60) connecting the lower part-supporting member (20) with the support (30); and

at least one wheel-connecting member (50) with a central part fixed on the lower part-supporting member (20), an upper part connected to the support-connecting member (60) and a lower part at which a wheel (70) is equipped, the wheel-connecting member (50) being rotated about its central axis fixed on the lower part-supporting member (20) by moving the support-connecting member (60) perpendicularly, which results in folding or unfolding of the wheel (70).

### TECHNICAL FIELD

The present invention relates to a carrier that can be loaded with a bag or all other varying articles, which can be carried in convenience. In specific, the present invention relates to a hand carrier designed to be loaded with a bag and to be drawn with a hand, or to be attached to a bag and to be carried on one's shoulder.

### BACKGROUND ART

Korean registration utility publication No. 20-316,317 discloses a hand carrier comprising a bottom part, a wall part extending upwardly from the edge of the bottom part and a support-connecting part equipped at the wall part, to which the lower part of a support is connected, in which at least at one side, a wheel installing part for installing the wheel is formed; and a bag to which the hand carrier is attached.

In addition, Korean registration utility publication No. 20-308823 describes a hand carrier, characterized by comprising a bottom part supporting a wheel and thereby making it to be rolled, a pair of vertical frame of the left and the right, which is fixed on the bottom part perpendicularly, of which contraction and expansion are accomplished by inserting the upper flame into the lower flame, and a grip connecting an upper part of the vertical flame; and a bag to which the hand carrier is attached.

However, the conventional hand carriers disclosed in the above-mentioned references had a fixed type wheel which is attached to the hand carriers and thus, it caused the following problems: By carrying a bag attached to the hand carriers on one's shoulder, one's cloth could be soiled with contaminants such as soil clung to the wheel of the carriers. Also, by entering a home, school or the like while carrying the bag, it could be stained due to contaminants. In addition, when carrying the bag on one's shoulder, exposed wheel would pose unattractive appearance. Such problems detracted from popularity among the consumers carrying the bag, mainly, the children. Moreover, because of design limitation, the height from the wheel to the bottom of the hand carrier or the main part of the bag was not so high. Therefore, when towing the prior art hand carrier having a bag with a hand, the bottom of the hand carrier could be stained with contaminants, such as soil.

### BRIEF EXPLANATION OF THE DRAWING

FIG. 1 is a perspective view representing one embodiment of the hand carrier according to the present invention.

FIG. 2 is a perspective view showing a connecting part of the support-connecting member with the wheel-connecting member in one of the embodiments of the hand carrier according to the present invention.

FIG. 3 is a partial perspective view for illustrating the structure of one of the embodiments of the hand carrier according to the present invention.

FIG. 4 is a perspective view showing the structure of one of the embodiments of the hand carrier according to the present invention, from a view of the side of the lower part.

FIG. 5 includes a front, side and top views, showing one of the embodiments of the hand carrier according to the present invention.

FIG. 6 illustrates changing the position of the wheel by pulling and pushing the grip in one of the embodiments of the hand carrier according to the present invention.

FIG. 7 is a perspective view representing the shape in which the wheel is folded in one of the embodiments of the hand carrier according to the present invention.

FIG. 8 is a perspective view representing a structure of the hand carrier in which the wheel is folded, with a view from the side of the bottom part, in one of the embodiments of the hand carrier according to the present invention

FIG. 9 is a perspective view representing a structure of one of the embodiments of the hand carrier according to the present invention in the form of which the cover of the lower part is completely closed by a sliding door, with a view from the side of the bottom part.

FIG. 10 is a perspective view representing another embodiment of the hand carrier according to the present invention, with one support.

FIG. 11 is a perspective view representing the other embodiment of the hand carrier according to the present invention, with two supports.

FIG. 12 is a perspective view representing the other embodiment of the hand carrier according to the present invention, in which the wheel is folded in the front direction.

FIG. 13 is a perspective view showing a connecting part of the support-connecting member with the wheel-connecting member, in the other embodiment of the hand carrier according to the present invention, in which the wheel is folded in the front direction.

FIG. 14 is a perspective view showing a bag that is attached to one of the embodiment of the hand carrier according to the present invention.

* Explanation on marks in the main parts of the figures.

10: hand carrier

20: lower part-supporting member

30a: fixed type support

30b: first movable support

30c: second movable support

40: cover of the lower part

50: wheel-connecting member

60: support-connecting member

70: wheel

80: grip

90a, 90b, 90c: shaft

100: sliding door

110: rail

### THE DETAILED DESCRIPTION OF THE INVENTION

The object of the present is to provide a hand carrier which can be towed by hand without being stained with ground contaminants such as soil or which can be carried on one's shoulder by attaching a bag without being stained with contaminants such as soil, by solving the above problems. Another object of the present invention is to provide an attractive hand carrier by not exposing the wheel even while being attached to the bag and being carried.

The hand carrier (10) according to the present invention for achieving the above objects comprises

a lower part-supporting member (20);

at least one support (30) perpendicularly connected to the lower part-supporting member (20) and equipped with a grip (80) at the end of its upper part;

at least one support-connecting member (60) connecting the lower part-supporting member (20) with the support (30); and

at least one wheel-connecting member (50) with a central part fixed on the lower part-supporting member (20), an upper part connected to the support-connecting member (60) and a lower part at which a wheel (70) is equipped, the wheel-connecting member (50) being rotated about its central axis fixed on the lower part-supporting member (20) by moving the support-connecting member (60) perpendicularly, which results in folding or unfolding of the wheel (70).

In the hand carrier (10) according to the present invention, the support (30) may consist of a) a fixed type support (30a) perpendicularly connected to the lower part-supporting member (20), which is not movable and b) a movable support (30b) connected to the fixed type support (30a), with a grip (80) at the end of its upper part, which is movable upwardly and downwardly and the movable support (30b) being connected to the support-connecting member (60).

In the hand carrier (10) according to the present invention, the support (30) may consist of a) a fixed type support (30a) perpendicularly connected to the lower part-supporting member (20), which is not movable; b) the first movable support (30b) connected to the fixed type support (30a), which is movable upwardly and downwardly; and c) the second movable support (30c) connected to the first movable support (30b), with a grip (80) at the end of its upper part, which is movable upwardly and downwardly and the first movable support (30b) being connected to the support-connecting member (60).

The hand carrier (10) according to the present invention may comprise at least three different supports (30). In addition, the support and the support-connecting member (60) may be in a single body. Preferably, the support (30) consists of a fixed type support (30a), the first movable support (30b) and the second movable support (30c).

In the present invention, the lower-part supporting member (20) may have a hollow support-connecting part, with a cross-section in the form of a polygon or circle etc. Preferably, the hollow support-connecting part may have a cross-section in the form of quadrangle. The support-connecting part connects not only the lower part-supporting member (20) with the support (30) but also the lower part-supporting member (20) with the support-connecting member (60). Preferably, the connection of the lower part-supporting member (20) with the support (30) and a connection of the lower-part supporting member (20) with the support-connecting member (60) are accomplished by inserting the support (30) and the support-connecting member (60) into the support-connecting part. It is also preferred that the insertion of the support (30) and the support-connecting member (60) into the support-connecting part is conducted in the opposite direction from each other.

The support-connecting member (60) connects with the support (30) as mentioned above and upon the support (30) moves, the support-connecting member (60) can move along with the support (30). The support-connecting member (60) also connects with the upper part of the wheel-connecting member (50). Therefore, if the support (30) moves perpendicularly, the support-connecting member (60) moves perpendicularly and then the wheel-connecting member (50) moves.

The wheel-connecting member (50) has an upper part, a central part and a lower part. An upper part of the wheel-connecting member (50) connects with the support-connecting member (60), a central part of the wheel-connecting member (50) is fixed on the lower part-supporting member (20) and a lower part connects with a wheel (70). A connection of the wheel-connecting member (50) with the support-connecting member (60) may be accomplished by a method known in this field. Preferably, the upper part of the wheel-connecting member (50) may have a connecting opening into which the shaft may be inserted. Consequently, the wheel-connecting member (50) connects with the support-connecting member (60). The diameter or circumference of the connecting opening at least at one direction must be larger than that of shaft (90c) so that the perpendicular movement of the support-connecting member (60) may be converted to the rotation movement of the wheel-connecting member (50) about the opening axis. For example, the shaft (90c) has a cross-section of a circular form, it is preferred that the opening has an oval form, of which diameter at one direction is larger than that of shaft (90c). The central part of the wheel-connecting member (50) is fixed on the lower part-supporting member (20). The fixing can be used by a method known in this field. For example, a method of fastening a volt with a nut can be considered. In addition, in case that the central part of the wheel-connecting member (50) has a opening, inserting the shaft (90) into the opening also can be considered.

On the wheel-connecting member (50), the wheel (70) is fixed. The fixation of the wheel (70) can be accomplished by the various known methods. Preferably, the shaft (90a) can be used. In addition, the wheel (70) and the wheel axis can be in one body and fixed on the wheel-connecting member (50). In case that the wheel (70) and the wheel axis can be separated from each other, the ring for preventing the separation from the wheel axis also can be used. A luminous wheel can be used as a wheel.

In the present invention, the support (30), the support-connecting member (60) and the wheel-connecting member (50) each may exist in pairs consisting of the left and the right. The upper ending parts of the supports (30), located at the most upper part, may be connected by the grip (80).

In the hand carrier (10) according to the present invention, the lower part-supporting member (20) has a cover (40) at its bottom. Preferably, to the cover (40), a sliding door (100), which moves along rails and can be opened or closed, is attached.

<Operation Procedure>

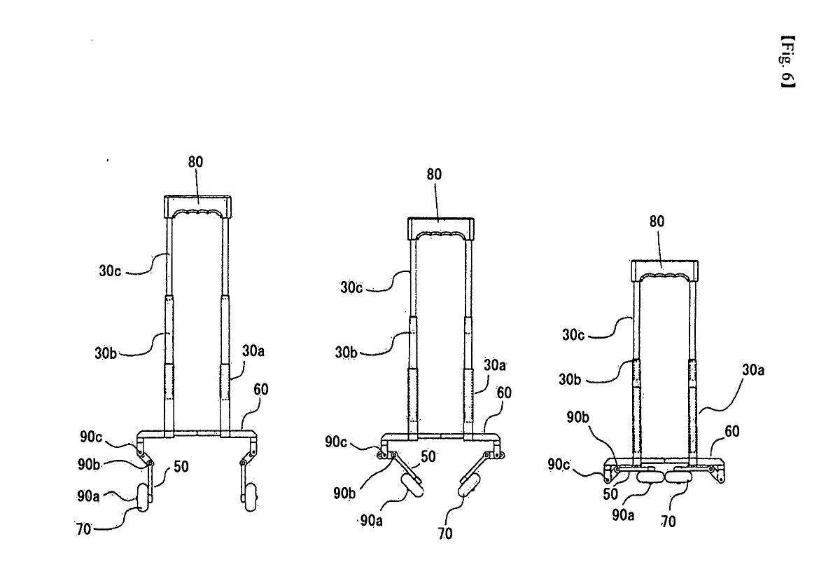

An operation procedure in which the wheel (70) of the hand carrier (10) is folded into the lower part-supporting member (20) will be explained hereinafter (see FIG. 6).

1. Push a grip (80) downwardly.

2. The grip (80) and a support (30) move downward.

3. The migration of the support (30) causes the support-connecting member (60) attached to the support (30) to move downward.

4. The migration of the support-connecting member (60) causes the wheel-support member (50) to rotate on its central axis, causing a wheel (70) to migrate upwardly and become folded into the lower part-supporting member (20).

In specific,

a. First, a support-connecting member (60) moves downwardly and the upper part of the wheel-connecting member (50) is also pushed downward. This is because the support-connecting member (60) and the upper part of the wheel-connecting member (50) are connected with each other.

b. Simultaneously with downwardly movement of the upper part of the wheel-connecting member (50), the lower part of the wheel-connecting member (50) rotates about its central axis and moves upwardly. This is because the central axis of the wheel-connecting member (50) is fixed on the lower part-supporting member (20).

c. A rotation of the lower part of the wheel-connecting member (50) causes the wheel (70) connected to the lower part of the wheel-connecting member (50) to move upwardly so that the wheel (70) is folded into the lower part-supporting member (20).

5. If a grip (80) moves in the reversed direction, that is, upwardly, the entire procedure operates in the reversed order. The wheel-connecting member (50) rotates in the opposite direction and the wheel (70) unfolds out of the lower part-connecting member (20).

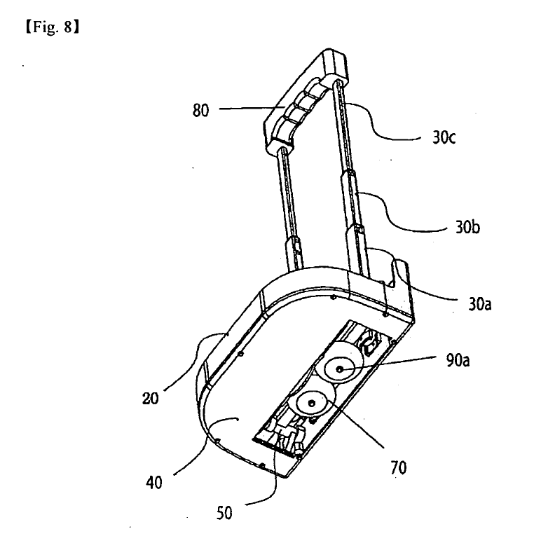

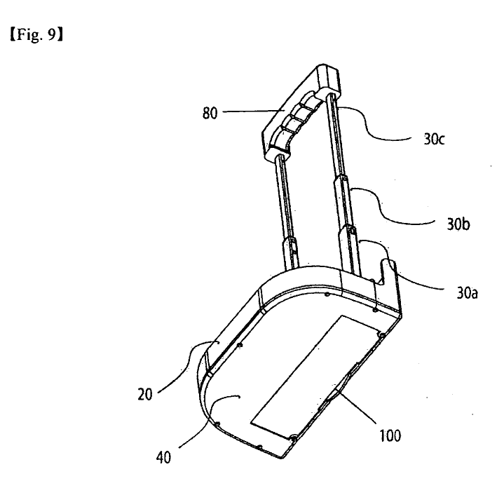

* When a wheel (70) is not used, the wheel (70) can be completely concealed by attaching a sliding door (100) into the cover (40) at the lower part of the lower-part supporting member (20) (see FIGS. 8 and 9).

### BEST MODE FOR CARRYING OUT THE INVENTION

Referring to the attached figures, the preferable example of the present invention will be explained below.

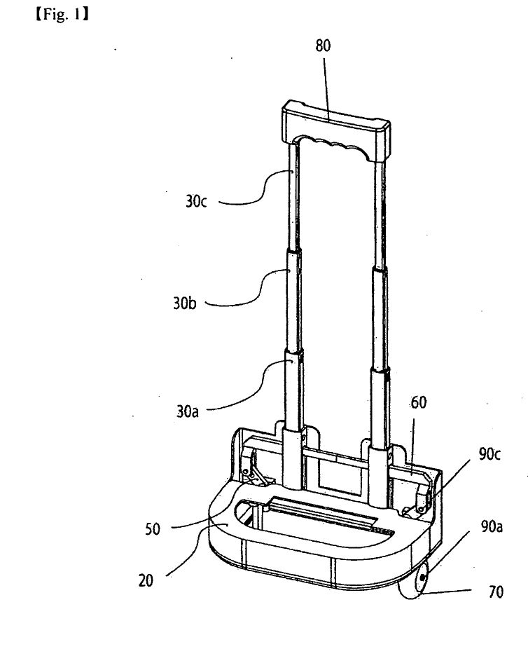

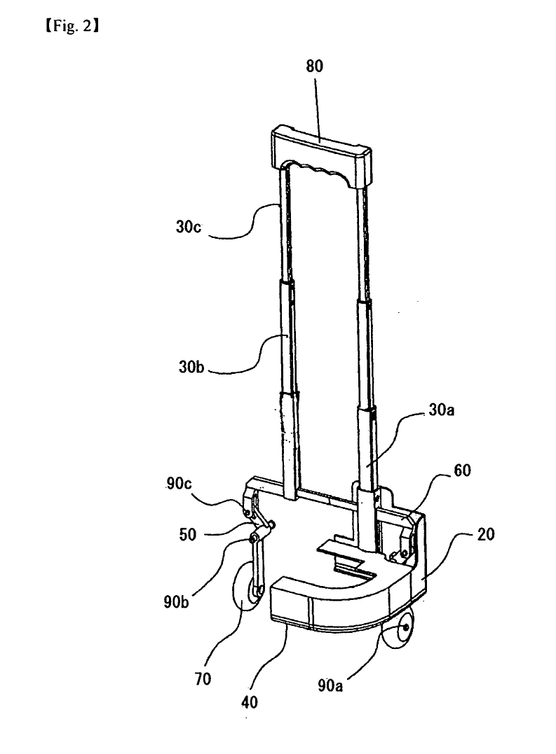

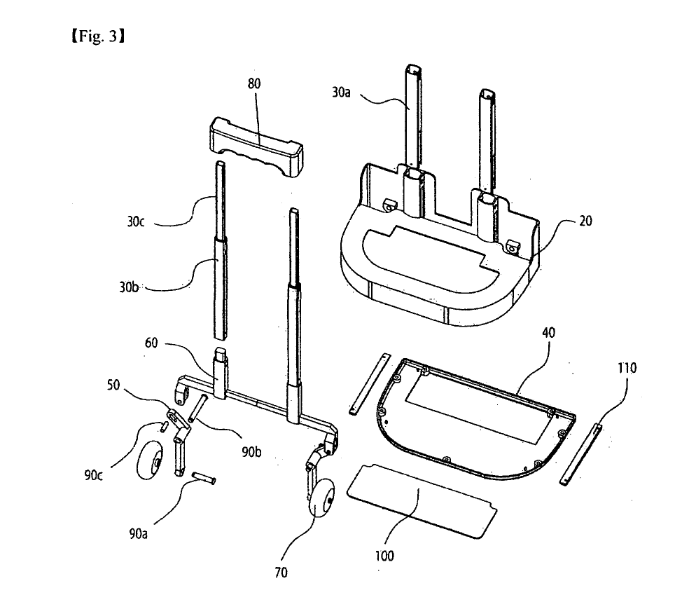

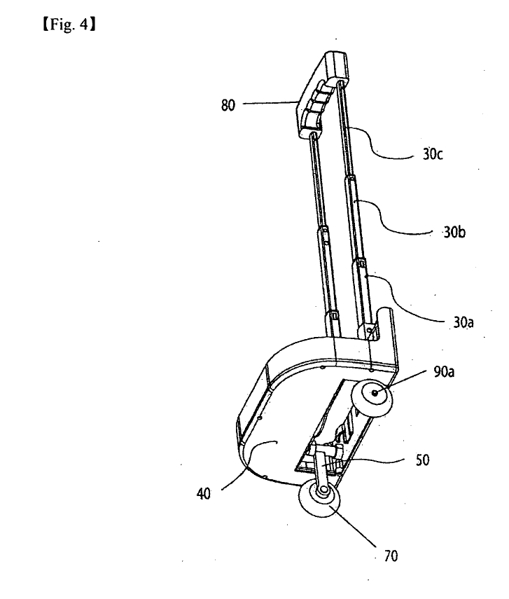

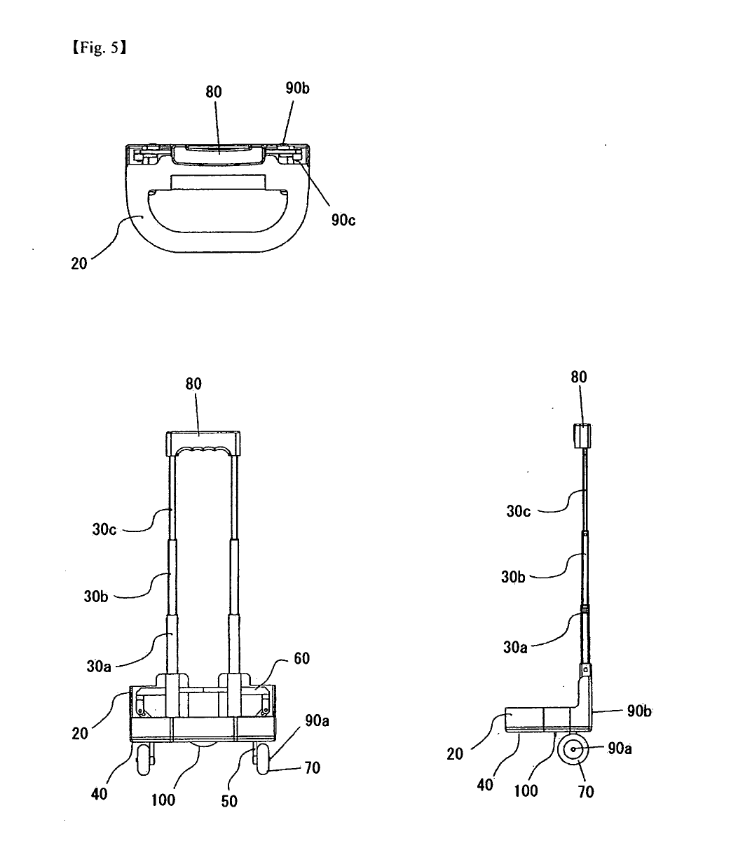

FIG. 1 is a perspective view representing one embodiment of the hand carrier (10) according to the present invention, which comprises a pair of support (30), a pair of support-connecting member (60) and a pair of wheel-connecting member (50), in which the support (30) consists of a fixed type support (30a), the first movable support (30b) and the second movable support (30c). FIG. 2 is a perspective view showing a connecting part of the support-connecting member with the wheel-connecting member (50) in one of the embodiments of the hand carrier (10) according to the present invention. FIG. 3 is a partial perspective view for illustrating the structure of one of the embodiments of the hand carrier (10) according to the present invention. FIG. 4 is a perspective view showing the structure of one of the embodiments of the hand carrier (10) according to the present invention, from a view of the side of the lower part. FIG. 5 includes a front, side and top views, showing one of the embodiments of the hand carrier (10) according to the present invention.

As shown in FIGS. 2 and 3, the hand carrier (10) according to the present invention comprises a lower part-supporting member (20) with a connecting part. A support-connecting member (60) is inserted into the connecting part of the lower part-supporting member (20) and fixed on the lower part-supporting member (20) (see FIG. 3, Right). A fixed type support (30a) is fixed by inserting a pin(s) into the opening in the connecting part of the lower part-supporting member (20).

The first movable support (30b) connected to the support-connecting member (60) is inserted into the upper part of the fixed type support (30a) and is movable upwardly and downwardly. When the first movable support (30b) moves downwardly, the support-connecting member (60) which is connected to the first movable support (30b), moves downwardly, as well.

The second movable support (30c) is inserted into the upper part of the first movable support (30b) and is movable upwardly and downwardly. There is a grip (80) at the end of the upper part of the second movable support (30c). The inner part of the first movable support (30b), into which the second movable support (30c) is introduce, has a groove, which engages the ending part of the second movable support (30c) and can control to stop the perpendicular movement of the second movable support (30c) at each stages.

Upon pushing a grip (90) downwardly, the second movable support (30c) connected to the grip (90) moves downwardly so that the second movable support (30c) is inserted into the first movable support (30b).

The wheel-connecting member (50) comprises at its upper ending part connecting opening which connects with the support-connecting member (60) (see FIG. 3). A connection of the wheel-connecting member (50) with the support-connecting member (60) is provided by shaft (90c), at the connecting opening of the wheel-connecting member (50). The connecting opening has an oval form, of which diameter at the longest direction is larger than that of shaft (90c). The perpendicular movement of the support-connecting member (60) may be converted to the rotation movement of the wheel-connecting member (50) about the central axis.

Shaft (90a) makes the wheel (70) fixed on the wheel-connecting member (50).

FIG. 6 illustrates the shift of the position of the wheel (70) by pulling and pushing the grip (80) in one of the embodiments of the hand carrier (10) according to the present invention.

One who uses the hand carrier may load the hand carrier (10) with a bag or other varying articles and carry it (them) in easy and convenience. If needed, one may attach a bag to the hand carrier and carry the bag on one's shoulder in easy and convenience.

First figure of FIG. 6 shows the hand carrier (10) loaded with a bag or other varying articles, which is carried. That is, FIG. 6 illustrates the hand carrier (10) before pushing a grip (80) of the hand carrier (10) where the wheel (70) is exposed out of the lower part-supporting member (30), as shown in FIGS. 2 and 4. As shown the figures, the wheel (70) completely projected out from the lower-support member (20) before pushing the grip (80) of the hand carrier (10) downwardly. Thus, the user of the hand carrier (10) may load the hand carrier (10) with a bag or other varying articles and carry it by hand. As shown in FIGS. 2 and 4, there is an enough space between the wheel-connecting member (50) and the lower part-connecting member (60). Therefore, even the case that the user tilts and draws the hand carrier (10), the bottom of the hand carrier (10) or the bottom of the bag attached to the hand carrier (10) is less stained with the containments such as soil.

On the other hand, in carrying a bag attached to the hand carrier (10) on one's shoulder or in entering a home or school or the like while carrying the bag, folding the wheel (70) is preferred. It prevents the wheel from being stained with the contaminants which can contact with the human body or cloth. It also prevents the home or school or the like from being stained due to contaminants.

The second figure of FIG. 6 shows the hand carrier (10) in that the wheel (70) is folded when pushing the grip (80) downwardly to halves. The third figure of FIG. 6 illustrates the hand carrier (10) in that the wheel (70) is completely folded when pushing the grip (80) downwardly to the end. As shown above, if the grip (80) is pushed downwardly, the second movable support (30c) moves downwardly and at last, it is inserted into the first movable support (30b). The first movable support (30b) connected to the second movable support (30a) also moves downwardly and it causes the support-connecting member (60) attached to the support (30) to move downward. Using the shaft (90b), the support-connecting member (60) is connected to the connecting opening which is located at the upper part of the wheel-connecting member (50). The wheel-connecting member (50) is fixed on the lower part-supporting member (20) using shaft (90b). When the support-connecting member (60) moves downwardly, the upper part of the wheel-connecting member (50) which is connected to the support-connecting member (60) moves downwardly. Since a central part of the wheel-connecting member (50) is fixed on the lower part-supporting member (20) with the help of shaft (90b), the lower part of the wheel-connecting member (50) connected to the wheel (70) rotates around shaft (90b) axis and moves upwardly. It causes the wheel (70) is folded into the lower part-supporting member (20). In other words, a perpendicular movement of the support-connecting member (60) is changed into the rotation movement rounding about the shaft (90b) axis. As a result, the wheel-connecting member (50) rotates. If a grip (80) moves in the reversed direction, that is upwardly, the entire procedure operates in the reversed order. The wheel-connecting member (50) rotates in the opposite direction and the wheel (70) unfolds out of the lower part-connecting member (20).

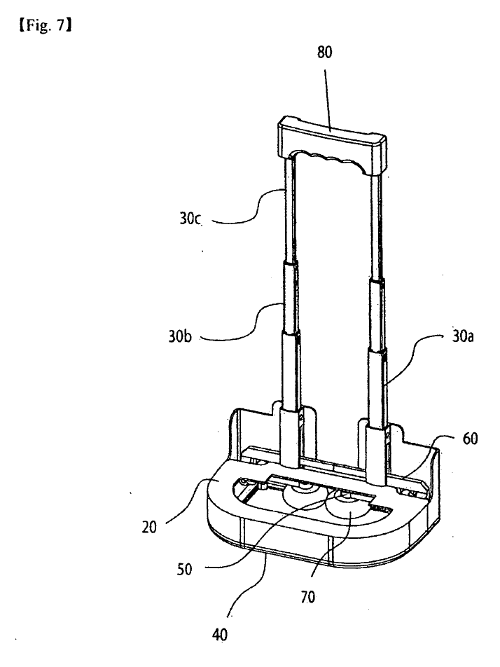

FIG. 7 is a perspective view representing the shape in which the wheel (70) is folded in one of the embodiments of the hand carrier (10) according to the present invention.

FIG. 8 is a perspective view representing a structure of the hand carrier (10) in which the wheel (70) is folded, with a view from the side of the bottom part, in one of the embodiments of the hand carrier (10) according to the present invention

FIG. 9 is a perspective view representing a structure of one of the embodiments of the hand carrier (10) according to the present invention in the form of which the cover (40) of the lower part is completely closed by the sliding door (100), with a view from the side of the bottom part.

The lower part-supporting member (20) has a cover (40) at its lower part, to which a sliding door (100) is attached. The sliding door (100) moves along the rail (110). In case of not using the wheel (70), if the user moves the sliding door (100), the wheel (70) can be perfectly concealed into the lower part-supporting member (20) of the hand carrier (10). In carrying the hand carrier (10) to which the wheel (70) is attached into the home, school or the like, the problems that the home, school or the like is stained with containments can be solved by making the wheel (70) not to be exposed out.

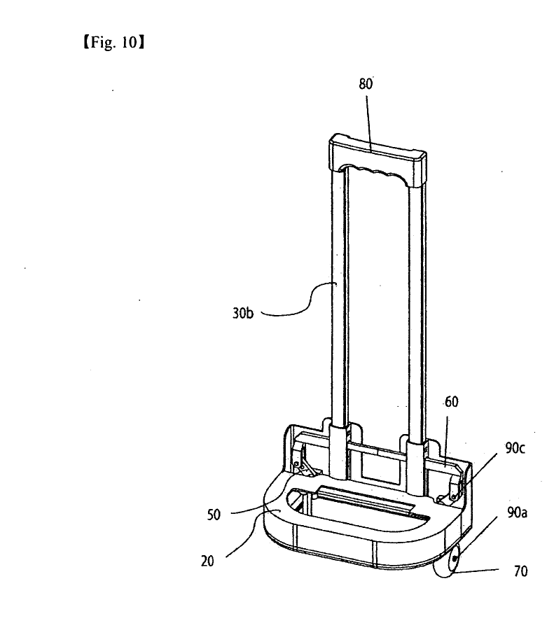

FIG. 10 is a perspective view representing another embodiment of the hand carrier (10) according to the present invention, with one support (30). In the hand carrier (10) of FIG. 10, the support (30) consists of only one movable support (30b).

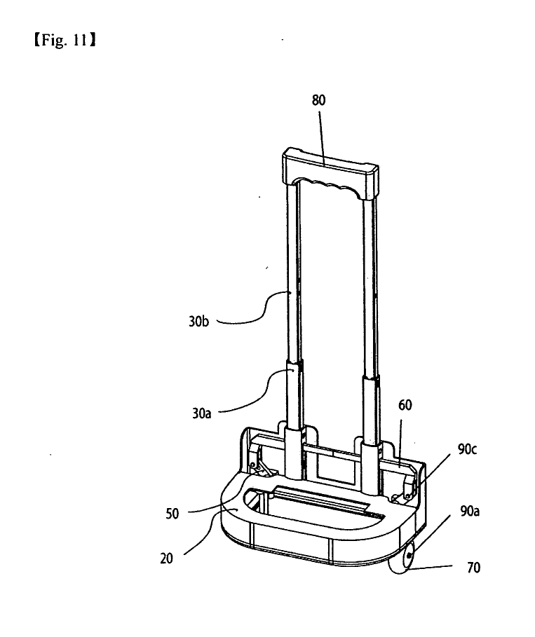

FIG. 11 is a perspective view representing the other embodiment of the hand carrier (10) according to the present invention, with two supports (30). In the hand carrier (10) of FIG. 11, the support (30) consists of only one fixed type support (30a) and one movable support (30b).

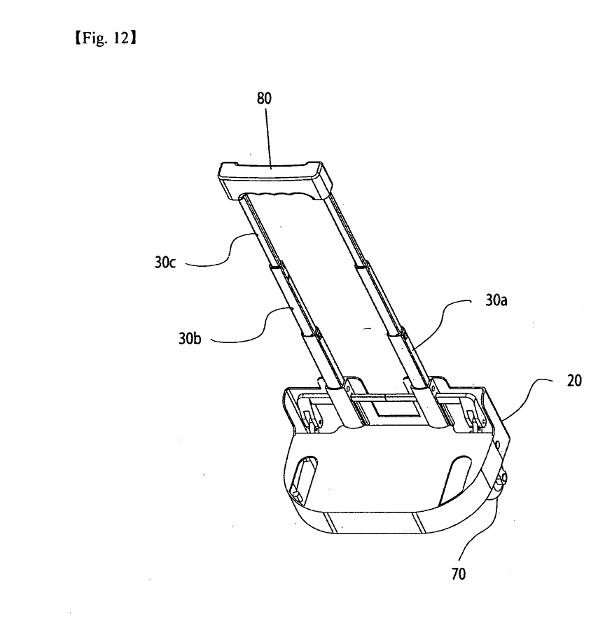

FIG. 12 is a perspective view representing the other embodiment of the hand carrier (10) according to the present invention, in which the wheel (70) is folded in the front direction.

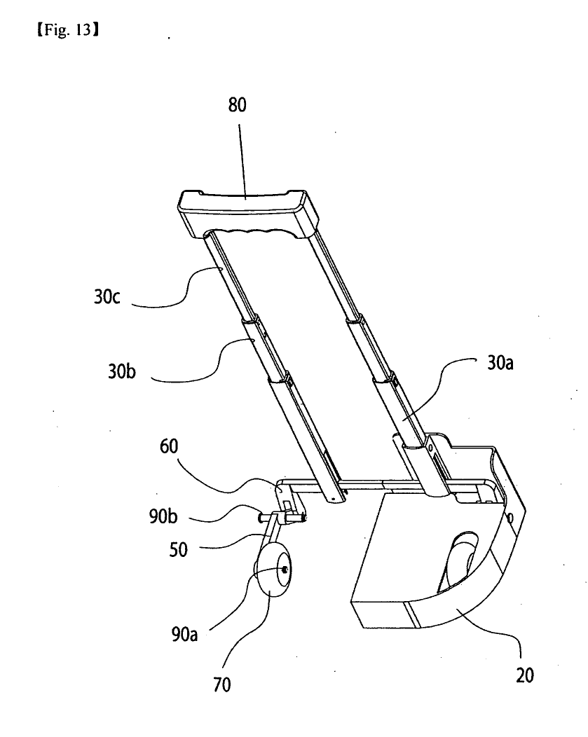

FIG. 13 is a perspective view showing a connecting part of the support-connecting member (60) with the wheel-connecting member (50), in the other embodiment of the hand carrier (10) according to the present invention, in which the wheel is folded in the front direction.

In FIGS. 12 and 13, the lower part-supporting member (20) has a space in which the wheel (70) can be folded. In the hand carrier of FIGS. 12 and 13, shaft (90b) can make the wheel-connecting member (50) being connected with the lower part-supporting member (20). The basic operation mechanism of them is the same as that of FIG. 1 except for the rotation axis.

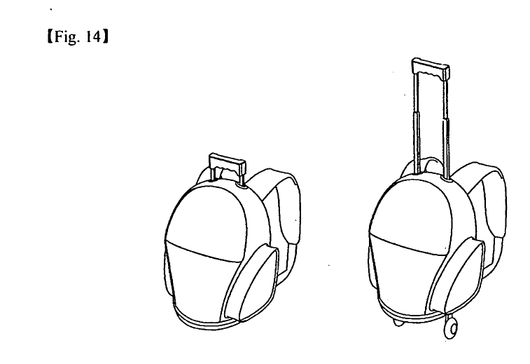

FIG. 14 is a perspective view showing a bag that is attached to one of the embodiment of the hand carrier (10) according to the present invention. Left of FIG. 14 shows the bag when pushing the grip (80) into the bag, that is, when carrying the bag on one's shoulder. Since the wheel (70) is folded, the appearance is pleasing to the eye and the cloth of man who carries the bag on one's shoulder is not stained with the containments. Right of FIG. 14 illustrates the bag in drawing the bag, that is, in pulling the grip (80). Because of enough space between the wheel (70) and the bottom.of the bag, even in drawing the bag by a hand, the bag may not be stained with the containments.

The examples shown the above are just selected from various examples in order to help the understanding of the skilled person in this field. The technical idea of the present invention is not limited to these examples. Various changes are possible within the scope of not escaping from technical idea of the present invention.

### INDUSTRIAL APPLICABILITY

As mentioned above, according to the hand carrier of the present invention, the wheel can be easily concealed into the lower part-supporting member. It may prevent a home, school or the like from being stained with the containments, upon entering the home, school or the like while carrying the hand carrier. In addition, in carrying a bag attached to the hand carriers on one's shoulder, it may prevent the cloth of a man who carries the bag from being stained with the containments. Further, it makes the appearance attractive and may give the user pleasing to the eye.

1. A hand carrier (10) comprising
a lower part-supporting member (20);
at least one support (30) perpendicularly connected to the lower part-supporting member (20) and equipped with a grip (80) at the end of its upper part;
at least one support-connecting member (60) connecting the lower part-supporting member (20) with the support (30); and
at least one wheel-connecting member (50) with a central part fixed on the lower part-supporting member (20), an upper part connected to the support-connecting member (60) and a lower part at which a wheel (70) is equipped, the wheel-connecting member (50) being rotated about its central axis fixed on the lower part-supporting member (20) by moving the support-connecting member (60) perpendicularly, which results in folding or unfolding of the wheel (70).

2. The hand carrier (10) according to claim 1, characterized in that the support (30)consists of
a) a fixed type support (30a) perpendicularly connected to the lower part-supporting member (20), which is not movable and
b) a movable support (30b) connected to the fixed type support (30a), with a grip (80) at the end of its upper part, which is movable upwardly and downwardly and the movable support (30b) being connected to the support-connecting member (60).

3. The hand carrier (10) according to claim 1, characterized in that the support (30) consists of
a) a fixed type support (30a) perpendicularly connected to the lower part-supporting member (20), which is not movable;
b) the first movable support (30b) connected to the fixed type support (30a), which is movable upwardly and downwardly; and
c) the second movable support (30c) connected to the first movable support (30b), with a grip (80) at the end of its upper part, which is movable upwardly and downwardly and
the first movable support (30b) being connected to the support-connecting member (60).

4. The hand carrier (10) according to claims 1 to 3, characterized in
that the lower-part supporting member (20) has a support-connecting part,
that a connection of the lower part-supporting member (20) with the support (30) and a connection of the lower-part supporting member (20) with the support-connecting member (60) are accomplished by inserting the support (30) and the support-connecting member (60) into the support-connecting part in the opposite direction from each other and
that a connection of the support (30) with the support-connecting member (60) is provided by shaft (90).

5. The hand carrier (10) according to claims 1 to 3, characterized in that the support (30), the support-connecting member (60) and the wheel-connecting member (50) each exists in pairs consisting of the left and the right, the pairs of the support (30) being connected by the grip (80).

6. The hand carrier (10) according to claim 4, characterized in that the support (30), the support-connecting member (60) and the wheel-connecting member (50) each exists in pairs consisting of the left and the right, the pairs of the support (30) being connected by the grip (80).

7. The hand carrier (10) according to claims 1 to 3, characterized in that the lower part-supporting member (20) has a cover (40) at its lower part, to which a sliding door (100) is attached.

8. The hand carrier (10) according to claim 4, characterized in that the lower part-supporting member (20) has a cover (40) at its lower part, to which a sliding door (100) is attached.

9. The hand carrier (10) according to claim 5, characterized in that the lower part-supporting member (20) has a cover (40) at its lower part, to which a sliding door (100) is attached.

10. The hand carrier (10) according to claim 6, characterized in that the lower part-supporting member (20) has a cover (40) at its lower part, to which a sliding door (100) is attached.
